(19) United States
(12) Patent Application Publication
(10) Pub. No.: US 2006/0276932 A1
(43) Pub. Date: Dec. 7, 2006

(54) Ice-making machinery with lockout and method

(75) Inventors: Garth K. Pearson, Lake Bluff, IL (US); William A. Litchy, Grayslake, IL (US); Daniel A. Jaszkowski, Racine, IL (US)

Correspondence Address: Paul D. Greeley;Ohlandt, Greeley, Ruggiero & Perle, L.L.P., 10th Floor, One Landmark Square, Stamford, CT, 06901-2682, US

(73) Assignee: Scotsman Ice Systems

(21) Appl. No.: 11/436,755

(22) Filed: May 18, 2006

Related U.S. Application Data
(60) Provisional application No. 60/682,759, filed on May 19, 2005.

(51) Int. Cl. F25C 1/00; G06F 17/00

(52) U.S. Cl. 700/237; 62/135

(57) ABSTRACT

An ice-making machine and method that control the ability of an ice-making machine to make ice in response to the occurrence of lockout events, which may be due to part malfunction, power load maintenance, failure to make lease payments and other concerns. Upon the occurrence of a lockout event, a message is sent from a remote site and received by a receiver associated with the ice-making machine. The message includes a lockout command that is transferred to a controller of the ice-making machine. The controller then disables the ice-making machine from making ice.

### RELATED APPLICATION

This application claims the benefit of U.S. Provisional Patent Application, Ser. No. 60/682,759, filed May 19, 2005, the entire contents of which are hereby incorporated by reference.

### FIELD OF THE INVENTION

This invention relates to ice-making machinery and to a method for controlling the ability of the ice-making machinery to make ice.

### BACKGROUND OF THE INVENTION

Ice-making machines are used to make ice in various forms, such as ice cubes, flakes and the like. Ice-making machines generally include an evaporator, a refrigerant supply, a water supply, a controller and an ice bin. Ice-making machines that make cubes have a freeze cycle and a subsequent harvest cycle. During the freeze cycle, the evaporator is cooled by liquid refrigerant provided by the refrigerant supply so as to form ice cubes from water provided by the water supply. During the harvest-cycle, the evaporator is warmed by hot gas that is provided by the refrigerant supply to free the ice cubes, which then fall into the ice bin. During the freeze cycle and the harvest cycle, the controller controls the refrigerant supply and the water supply. Ice-making machines that make flakes operate continuously to form ice on a surface of the evaporator, which is mechanically removed by an augur. For either cube or flake ice-making machines, the controller also controls other operations such as, cleaning or rinsing of all surfaces that contact water or ice.

When an ice-making machine is leased by a lessor to a customer lessee, certain events can occur that give rise to a need to disable the ice-making machine from making ice. One example is due to discovery of a part that, if not quickly repaired or replaced, could malfunction and cause damage to other parts of the ice-making machine. Another example is a need to shut down the ice-making machine due to load management requirements of power companies. Another example is that the lessee has failed to make payments pursuant to the lease agreement to the detriment and harm of the lessor. It is difficult to disable current ice-making machines for such events as the ice-making machine is in the custody of the lessee, who may be unavailable when the event occurs.

Thus, there is a need to disable the ice-making machine when such an event occurs.

There is a need for an ice-making machine and a method that are capable of remotely enabling and/or disabling the operation of the ice-making machine.

### SUMMARY OF THE INVENTION

A method of the present invention comprises leasing an ice-making machine to a customer by entering into a lease agreement with the customer, wherein the customer has use of the ice-making machine during a term of the lease agreement. A message is sent to the ice-making machine that disables the ice-making machine from making ice in the event of an occurrence of a lockout event.

In one embodiment of the method of the present invention, the ice-making machine is disabled only if a unique identifier of the message matches at least a part of a serial number of the ice-making machine.

In another embodiment of the method of the present invention, the message is sent via a network and received by the ice-making machine.

In another embodiment of the method of the present invention, the network is one of the group consisting of: Internet, paging, telephone and cellular telephone.

In another embodiment of the method of the present invention, the lockout event is one of the group consisting of: part malfunction event, power load maintenance event and failure to timely make a payment pursuant to the lease agreement.

In another embodiment of the method of the present invention, the message comprises a command to disable. The ice-making machine comprises a controller and a receiver, which receives the message. The message is transferred from the receiver to the controller to disable the ice-making machine.

In another embodiment of the method of the present invention, the message is sent from a computing device that comprises a program that responds to the occurrence of the lockout event to cause the sending of the message.

In another embodiment of the method of the present invention, the ice-making machine is also disabled if a connection between the receiver and controller is disconnected.

An ice-making machine of the present invention comprises an ice-making assembly, a receiver and a controller. The controller controls the ice-making assembly to make ice and is responsive to a message from a remote sender received by the receiver to disable the ice-making assembly from making ice.

In one embodiment of the ice-making machine of the present invention, the ice-making assembly remains disabled until the controller responds to another message received by the receiver to enable the the ice-making assembly to make ice.

In another embodiment of the ice-making machine of the present invention, each of the messages comprises a unique identifier and a command.

In another embodiment of the ice-making machine of the present invention, the controller further comprises a memory that stores a serial number of the ice-making machine. The controller responds to the messages only if the serial number matches the unique identifier.

In another embodiment of the ice-making machine of the present invention, the ice-making assembly comprises a water supply, a refrigerant supply and an evaporator.

In another embodiment of the ice-making machine of the present invention, the controller comprises a lockout program that comprises program instructions that enable or disable the ice-making assembly.

In another embodiment of the ice-making machine of the present invention, the program instructions cause the controller to enter a lockout mode.

In another embodiment of the ice-making machine of the present invention, the controller remains in the lockout mode until another message is received by the receiver. The program instructions respond to the other message to cause the controller to leave the lockout mode and be free to control the ice-making assembly to make ice.

In another embodiment of the ice-making machine of the present invention, the program instructions respond to other messages received by the receiver to activate and deactivate the controller.

In another embodiment of the ice-making machine of the present invention, the receiver receives the message from a network that is one selected from the group consisting of: Internet, telephone, cellular telephone and paging.

In another embodiment of the ice-making machine of the present invention, the ice-making assembly is also disabled if a connection between the receiver and controller is disconnected.

In another embodiment of a method of the present invention, an ice-making machine, which comprises a controller and an ice-making assembly, is controlled by receiving a message from a remote sender that comprises a lockout command. The message is transferred to the controller. The controller responds to the lockout command to disable the ice-making assembly from making ice.

In one embodiment of the method of the present invention, the ice-making machine comprises a receiver that receives the message, the receiver being a member of the group consisting of: pager, cellular telephone and browser.

In another embodiment of the method of the present invention, a subsequently received message comprises an unlock command. The subsequently received message is transferred to the controller, which responds to the unlock command to enable the ice-making assembly to make ice.

In another embodiment of the method of the present invention, the ice-making machine further comprises a receiver that is connected to the controller by a cable, wherein the ice-making machine is also disabled if the cable is disconnected.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a block diagram of an ice-making machine of the present invention;

FIG. 2 is a block diagram of a controller of the FIG. 1 ice-making machine; and

FIG. 3 is a board implementation of the controller of FIG. 2.

### DESCRIPTION OF THE PREFERRED EMBODIMENT

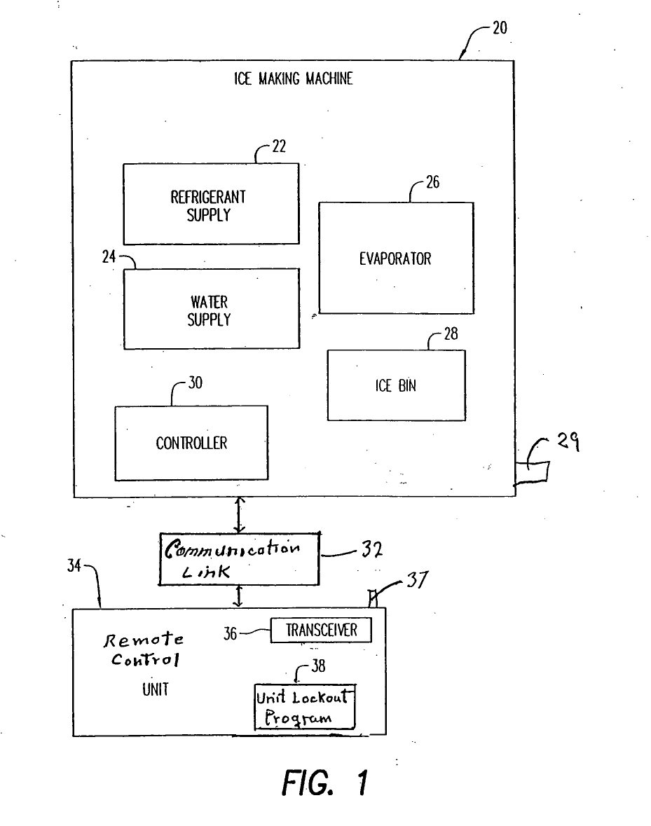

Referring to FIG. 1, an ice-making machine 20 includes a refrigerant supply 22, a water supply 24, an evaporator 26, an ice bin 28 and a controller 30. Refrigerant supply 22, water supply 24, evaporator 26 and ice bin 28 comprise an ice-making assembly that controller 20 controls to make ice. If ice-making machine 20 makes cubes, controller 30, during a freeze cycle, controls refrigerant supply 22 to provide liquefied refrigerant to cool evaporator 26 and further controls water supply 24 to supply water to the cooled evaporator so as to form ice on a surface thereof. During a subsequent harvest cycle, controller 30 controls refrigerant supply 22 to provide warm gasified refrigerant to evaporator 26 to free the ice cubes, which fall into ice bin 28. If ice-making machine 20 makes flakes, controller 30 controls refrigerant supply 22, water supply 24 and an augur. Ice-making machine 20 in some embodiments includes an antenna 29 for wireless communications.

Controller 30 is also arranged to communicate via a communication link 32 with a portable programmable unit 34. Communication link 32 may be any wired or wireless technology or a combination thereof that is capable of communicating control and/or data signals between ice-making machinery 20 and remote control unit 20. For example, communication link 32 may be an Internet, an Intranet, a paging link, a wired or wireless telephone link, a wireless link of any range and frequency. It is contemplated that wireless technologies that operate in the infrared portion, the radio frequency portion, the microwave portion, the visible portion or other portion of the frequency spectrum can be used. Remote control unit 32 may be any suitable computer device, known currently or in the future, that has a communication capability compatible with communication link 32, such as a desktop computer, a workstation, a server, a laptop computer, a hand held computing device and the like.

Remote control unit 34 includes a communication device that is capable of transmitting and receiving over communication link 32. In FIG. 1, this communication device is shown as a transceiver 36, which, e.g., could be used in conjunction with a paging service. Alternatively, transceiver 36 could be of the type that is used for other wireless communications, such as a cellular telephone communication. In other embodiments, where the local port of the communication link is wired, transceiver 36 may include appropriate modem and browser instrumentalities.

Remote control unit 34 further includes an antenna 37 for wireless communications and a unit lockout program 38. Unit lockout program 38 causes remote control unit 34 to transmit a control message to ice-making machine 20 that will either enable or disable the operation of ice-making machine 20.

Unit lockout program 38 comprises program steps that cause enable or disable control messages to be sent to ice-making machine 20. These program steps can be initiated in response to an event. For example, the event could occur due to a safety, public health, non-performance of an obligation to the vendor/lessor of ice-machine 20 or other event. The occurrence of the event could be input to remote control unit. Alternately, the event could be automatically tracked and its occurrence communicated to unit lockout program 38.

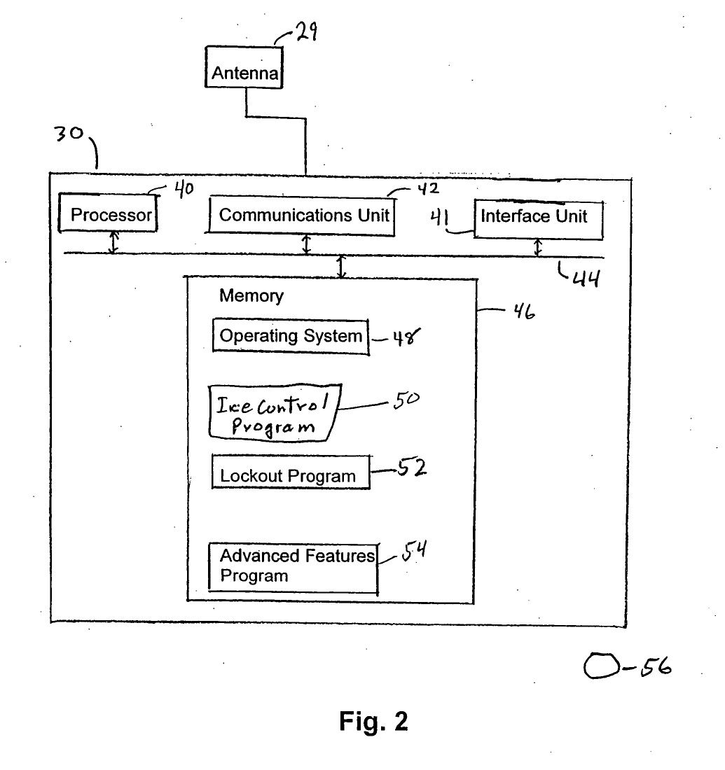

Referring to FIG. 2, controller 30 includes a processor 40, an ice making machine interface unit 41, a communications unit 42 and a memory 46 that are interconnected via a bus 44. Memory 46 includes an operating system 48, an ice control program 50, a lockout program 52 and an advanced features program 54. Other programs, such as utilities and other applications, may also be stored in memory 46. All of these programs may be loaded into memory 46 from a storage medium, such as a disk 56 via a direct connection or via portable programmable unit 34. Communications unit 42 includes a communication instrumentality that is compatible with communication link 32. By way of example, the communication instrumentality may be a transceiver (not shown in FIG. 2).

Processor 40 is operable under the control of operating system 48 to execute ice control program 50 to control the freeze, harvest and other cycles of ice-making machine 20 as well as the operations of lockout program 52 and advanced features program 54.

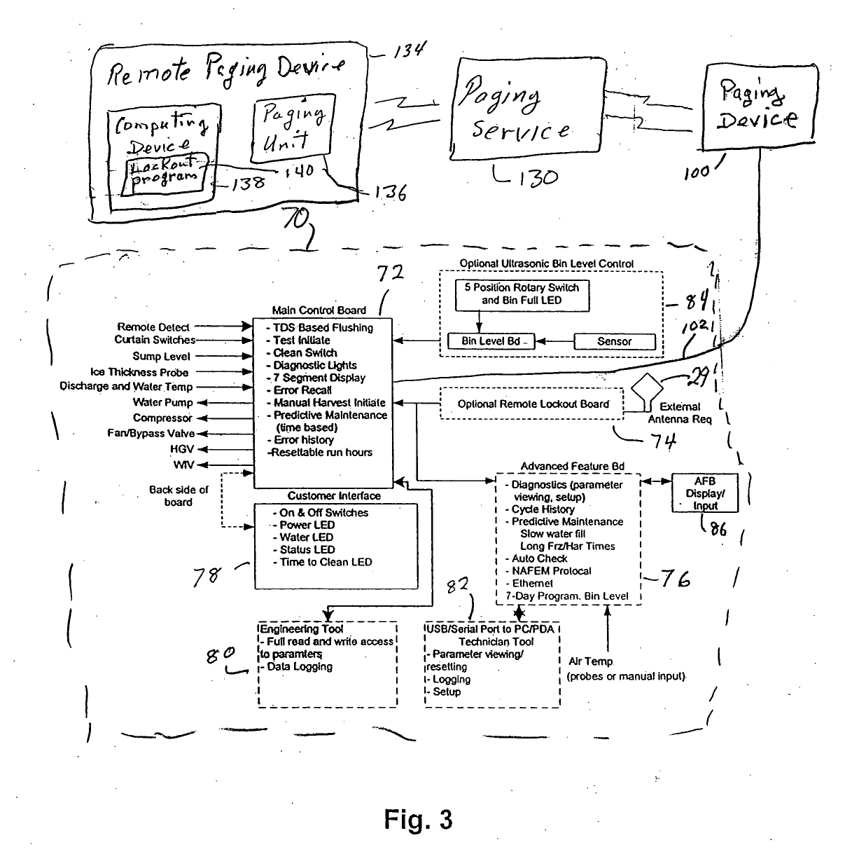

Referring to FIG. 3, a board implementation 70 comprises a main control board 72, an optional lockout board 74, an advanced features board 76 and an ultrasonic bin level control board 84. A customer interface 78 is a part of main control board 72. An engineering tool 80 is a separate program that interfaces with main control board 72 via a PC (not shown). A technician tool board 82 is a separate program that runs on a portable computer (not shown) to interface with main control board 72. A display/input unit 86 is a part of advanced features board 76. Controller 30 is disposed on main control board 72 and is interconnected via interface unit 41 with lockout board 74, advanced features board 76 and ultrasonic bin level control board 84. Lockout board 74 is interconnected with antenna 29.

Remote lockout board 74 provides the ability to respond to a control signal or signals via antenna 29 to enable or disable the ability of controller 30 to initiate any action other than power-up diagnostics. For example, the control signals could initiate the setting and resetting of a flag which when set disables controller 30 and when reset enables controller 30. The lockout is not affected if the power is interrupted. When disabled via this function, controller 30 may annunciate that it has been remotely disabled, e.g., by a message on a display of ice-making machine 20, slowly flashing an LED, an audible signal, other signaling technique or any combination thereof. The control signals can be received via a communication link that may be any wired or wireless technology or a combination thereof as described above. Examples may include Internet, Intranet, paging service, telephone service, cellular telephone service and others.

In a paging embodiment of the present invention, a remote pager 134 communicates commands via a paging service 130 to a paging device 100 that is mounted on ice making machine 20. Paging device 100 is preferably mounted in a location that provides good reception of a paging signal. For example, paging device should be mounted on an outside wall of ice making machine 100, e.g., the back panel thereof. Paging device 100 may use antenna 29 or may have its own internal antenna.

Remote paging device 134 comprises a paging unit 136 and a computing device 138. Paging unit 136 may be a standard paging unit that is capable of receiving commands entered by hand or from computing device 138. Computing device 138 has an appropriate architecture, e.g., the architecture of FIG. 2. Computing device 138 comprises a unit lockout program 140.

Paging device 100 can be part of a field-installed add-on kit that also includes a cable 102 that connects paging device 100 to main control board 72, optional remote lockout board 74 not being used. Once installed and activated, ice making machine 20 can be shut down by sending it a page message that comprises a unique identifier of ice-making machine 20 followed by a command, in this case “lock”. The unique identifier, for example, may be the last six digits of the serial number of ice-making machine 20. This type of command uses sub-addressing which means that to address a particular ice-making machine, the last six digits of the serial number of the ice-making machine must be sent prior to the command. Lockout program 52 of controller 30 compares the unique identifier to the last six digits of the serial number stored in the EEPROM (which may be a part of memory 46) and only responds if there is a match. This allows one account to service many ice making machines. This would allow a leasing company to have one account with paging service 130 setup for all of the leasing company's ice making machines instead of having to open up one account for each leased ice making machine.

If cable 102 is disconnected, lockout program 52 will control ice-making machine 20 to proceed into a lock out mode after completing a current freeze/harvest cycle or immediately if ice-making machine 20 is not running. Lockout program 52 then controls ice-making machine 20 to stay locked out until cable 102 is reconnected.

After installation of the add-on kit, lockout program 52 will not react to paging device 100 until it has been activated.

An operator uses remote paging device 134 to send command messages to paging device 100. The activation command then is the unique identifier (the last six digits of the serial number) followed by the word “activate”, i.e., “100011 activate”. Lockout program 52 responds by setting a bit in memory 46 of controller 30. Lockout program 52 compares the unique identifier to the last six digits of the serial number of ice-making machine 20. If there is no match, the page message is ignored. If there is a match, lockout program 52 then looks for a signal coming back from paging device 100. This signal will be an enabled output on paging device 100 that will pull a line low on cable 102. This provides a tamper-proofing feature.

To lockout ice making machine 20, remote paging device 134 sends paging device 100 a lockout command comprising the last six digits of the serial number followed by the word “lock”. Lockout program responds by waiting for ice-making machine 20 to finish a current cycle (if running) and then causes ice-making machine 20 to enter a lock out mode. Ice-making machine 20 will also go to lockout mode if cable 102 is unplugged from main control board 72 or paging device 100. This provides a tamper proof feature by which the ice-making machine is placed in lockout mode if cable 102 is unplugged or otherwise disconnected.

Lockout program 52 is further operable to control ice-making machine 20 to stay in the lockout mode until either an “unlock” page is sent or cable 102 is plugged back in. If ice-making machine 20 was shut down with the lock command, unplugging cable 102 and plugging it back in would not unlock ice-making machine 20. But, unplugging cable 102 would disable ice-making machine 20 until it is plugged back in as described above.

The remote lockout feature can be deactivated by sending a page with the word “deactivate”.

A summary of the paging commands (where XXXXXX=last six digits of the ice making machine serial number) is as follows:
To Activate:
XXXXXX activate
To Lock Out Machine:
XXXXXX lock
To Unlock Machine:
XXXXXX unlock
To Deactivate:
XXXXXX deactivate

Optionally, lockout program 52 could format and provide a message to paging device 100 for transmission via paging service 130 to remote paging device 134. The message could be an acknowledgement of receipt and execution of any of the above described commands or other commands. Alternatively, the message could provide notice of machine conditions and/or status, for example, errors, maintenance needs and/or other content.

Board implementation 70 is one embodiment of the present invention that is useful when adding additional or optional features to an already existing main board design. It will be appreciated by those skilled in the art that other board implementations may be used comprising one or more boards.

The page commands can simply be entered into paging unit 136 by hand, in which case computing device 138 may be unnecessary.

In a preferred embodiment, remote paging device 134 comprises both paging unit 136 and computing device 138. Unit lockout program 140 comprises program steps to generate and provide the above described commands to paging unit 136 for transmitting to paging device 100 via paging service 130. Unit lockout program 140 initiates these program steps in response to the occurrence of a lockout event. For example, the lockout event could occur due to a part malfunction, power load maintenance need, a customer's non-performance of an obligation to the vendor/lessor of ice-machine 20 or other event. For example, a malfunction of a part of ice-making machine 20 that could cause damage to other parts of ice-making machine 20. A power load maintenance concern may require that ice-making machine be shut down. The obligation could be an obligation of a customer lessee to make payments pursuant to a lease agreement.

The occurrence of the lockout event can be manually input to computing device 138. Alternately, the lockout event could be automatically tracked by computing device 138 and its occurrence communicated to unit lockout program 140.

Some of these lockout events (e.g., power load maintenance) may need a mandatory response and others (e.g., non-performance of an obligation) may or may not need a response. Thus, lockout program 140 further comprises steps to handle such lockout events. If a mandatory response is needed, unit lockout program 140 generates and provides the needed commands to paging unit 134 for sending to paging device 100. If a non-mandatory response is needed, unit lockout program 140, based on a business policy, notifies an operator of the occurrence of the event. Unit lockout program 140 prompts the operator to okay or reject a sending of any of the above described commands to paging device 100.

The present invention having been thus described with particular reference to the preferred forms thereof, it will be obvious that various changes and modifications may be made therein without departing from the spirit and scope of the present invention as defined in the appended claims.

What is claimed is:

1. A method of leasing an ice-making machine to a customer comprising:
entering into a lease agreement with said customer wherein said customer has use of said ice-making machine during a term of said lease agreement; and
sending a message to said ice-making machine that disables said ice-making machine from making ice in the event of an occurrence of a lockout event.

2. The method of claim 1, wherein said ice-making machine is disabled only if a unique identifier of said message matches at least a part of a serial number of said ice-making machine.

3. The method of claim 1, wherein said message is sent via a network and received by said ice-making machine.

4. The method of claim 3, wherein said network is one of the group consisting of: Internet, paging, telephone and cellular telephone.

5. The method of claim 1, wherein said lockout event is one of the group consisting of: part malfunction event, power load maintenance event and failure to timely make a payment pursuant to said lease agreement.

6. The method of claim 1, wherein said message comprises a command to disable, and wherein said ice-making machine comprises a receiver and a controller, wherein said receiver receives said message, and wherein said message is transferred from said receiver to said controller to disable said ice-making machine.

7. The method of claim 6, wherein said ice-making machine is also disabled if a connection between said receiver and controller is disconnected.

8. The method of claim 1, wherein said message is sent from a computing device that comprises a program that responds to said occurrence of said lockout event to cause the sending of said message.

9. An ice-making machine comprising:
an ice-making assembly;
a receiver; and
a controller that controls said ice-making assembly to make ice and that is responsive to a message from a remote sender received by said receiver to disable said ice-making assembly from making ice.

10. The ice-making machine of claim 9, wherein said ice-making assembly remains disabled until said controller responds to another message received by said receiver to enable said ice-making assembly to make ice.

11. The ice-making machine of claim 9, wherein said message comprises a unique identifier and a command.

12. The ice-making machine of claim 11, wherein said controller further comprises a memory that stores a serial number of said ice-making machine, and wherein said controller responds to said message only if said serial number matches said unique identifier.

13. The ice-making machine of claim 9, wherein said ice-making assembly comprises a water supply; a refrigerant supply and an evaporator.

14. The ice-making machine of claim 9, wherein said controller comprises a lockout program that comprises program instructions that enable or disable said ice-making assembly.

15. The ice-making machine of claim 14, wherein said program instructions cause said controller to enter a lockout mode.

16. The ice-making machine of claim 15, wherein said controller remains in said lockout mode until another message is received by said receiver, and wherein said program instructions respond to said other message to cause said controller to leave said lockout mode and be free to control said ice-making assembly to make ice.

17. The ice-making machine of claim 14, wherein said program instructions respond to other messages received by said receiver to activate and deactivate said controller.

18. The ice-making machine of claim 9, wherein said receiver receives said message from a network that is one selected from the group consisting of: Internet, telephone, cellular telephone and paging.

19. The ice-making machine of claim 9, wherein said ice-making machine is also disabled if a connection between said receiver and controller is disconnected.

20. A method of controlling an ice-making machine that comprises a controller and an ice-making assembly, said method comprising:
receiving a message from a remote sender that comprises a lockout command; and
transferring said message to said controller, and wherein said controller responds to said lockout command to disable said ice-making assembly from making ice.

21. The method of claim 20, wherein said ice-making machine comprises a receiver that receives said message, and wherein said receiver is a member of the group consisting of: pager, cellular telephone and browser.

22. The method of claim 20, further comprising:
subsequently receiving another message that comprises an unlock command; and
transferring said unlock command to said controller, and wherein said controller responds to said unlock command to enable said ice-making assembly to make ice.

23. The method of claim 20, wherein said ice-making machine further comprises a receiver that is connected to said controller by a cable, and wherein said ice-making machine is also disabled if said cable is disconnected.
